(19) United States
(12) Patent Application Publication
(10) Pub. No.: US 2014/0366854 A1
(43) Pub. Date: Dec. 18, 2014

(54) METHOD FOR OPERATING A DRIVE ASSEMBLY AND DRIVE ASSEMBLY

(71) Applicant: VOLKSWAGEN AKTIENGESELLSCHAFT, Wolfsburg (DE)

(72) Inventors: Henrik Hoffmeyer, Hannover (DE); Paul Gnegel, Lehre (DE); Nils Lindenkamp, Braunschweig (DE); Joerg Theobald, Lehre (DE)

(21) Appl. No.: 14/366,976

(22) PCT Filed: Dec. 19, 2012
(86) PCT No.: PCT/EP2012/005261

§ 371 Date: Jun. 19, 2014

(30) Foreign Application Priority Data
Dec. 24, 2011 (DE) 10 2011 122 442.8

(51) Int. Cl. F02M 25/07

(52) U.S. Cl. CPC F02M 25/0726
USPC 123/568.12

(57) ABSTRACT

The present invention relates to a method for operating a drive assembly having a gasoline engine (1) and an exhaust gas cooling system. According to the method, combustion air fed through an inlet valve to a cylinder (3) of the gasoline engine (1) is compressed by an exhaust turbocharger (12) having a turbine (13) with variable turbine geometry. The inlet valve is closed before a piston in the cylinder (3) reaches bottom dead center. The exhaust gas fed to the turbine is cooled in a section of an exhaust gas line, in particular in the exhaust manifold.

The present invention relates to a method for operating a drive assembly having the features according to the generic part of claim 1. The invention also relates to a drive assembly having the features according to the generic part of claim 10.

This application claims the priority of German patent application DE 10 2011 122 442.8 dated Dec. 24, 2011. The disclosure content of this document is hereby incorporated in its entirety into the disclosure of the present application.

In vehicles such as, for example, passenger cars or trucks, drive assemblies normally configured as internal combustion engines are used to propel the vehicle. The internal combustion engines are normally Otto engines or diesel engines. In order to lower the operating costs and emissions of these vehicles as well as to increase the comfort of the vehicle, a number of improvements to internal combustion engines have been proposed to this effect in the past.

German patent application DE 101 59 801 A1, for instance, relates to an internal combustion engine having at least one supercharger that is driven by the exhaust gas flow of the internal combustion engine, and having an adjustable camshaft based on the Miller cycle. Another compressor stage, which is not driven by the exhaust gas flow of the internal combustion engine, is arranged in series or in parallel to the supercharger. At low rotational speeds of the internal combustion engine, the charge pressure is increased by activating the additional compressor stage. The additional compressor stage, which is not driven by the exhaust gas flow of the internal combustion engine, can be driven, for example, electrically. Such an electrically driven compressor stage is also referred to as an electric booster.

The Miller cycle is known from U.S. Pat. No. 2,670,595. A presentation of the Miller cycle can also be found in the article titled “Miller- and Atkinson-Zyklus am aufgeladenen Dieselmotor” (Miller and Atkinson Cycle in a Supercharged Diesel Engine) by E. Schiitting et al. in MTZ Motortechnische Zeitschrift, 2007, Volume 06, pages 480 to 485. With the Miller cycle, the intake valve is opened after the exhaust stroke in order to feed air to the cylinder. The intake valve is closed before the piston reaches the lowermost position of the intake stroke.

European patent specification EP 2 041 414 B1 relates to a method for operating an Otto engine in which at least one intake valve of the Otto engine is closed either very early or very late, and in which a combustion air flow fed to the Otto engine is compressed by a supercharger. At least at full load, a partial flow of recirculated exhaust gas is fed to the combustion air flow by exhaust gas recirculation, and the Otto engine is operated at a geometric compression ratio greater than 1:10.

German patent application DE 102 33 256 A1 relates to a method for igniting the fuel-air mixture in an Otto engine having direct fuel injection system with a precombustion chamber and with spark ignition in the precombustion chamber. The precombustion chamber is operatively connected to a small piston depression.

The thermodynamic efficiency of Otto engines is limited because of the throttling of the quantitative load control and because of the reduced compression ratio that are necessary in order to prevent engine knocking. The above-mentioned Miller cycle and the Atkinson cycle known from the state of the art constitute an approach towards dethrottling during partial load operation and possibly increasing the geometric compression ratio. Here, the air charge and the effective compression are reduced through an early or late closing of the intake valve. The term “air charge” describes the charge cycle quality and indicates the ratio of the actual air volume—fed to the cylinder during the intake stroke—to the theoretically maximum air volume. As a result, the engine is dethrottled and the compression end temperature and thus the knocking tendency are reduced. Moreover, the geometric compression can be increased. However, the Miller and Atkinson cycles known from the state of the art entail a substantial power loss.

Before this backdrop, the objective of the present invention is to increase the efficiency of an Otto engine without reducing the power of the engine.

This objective is achieved by a method for operating a drive assembly with an Otto engine according to claim 1 or by a drive assembly with an Otto engine according to claim 10. The dependent claims define preferred and advantageous embodiments and/or refinements of the invention.

According to the present invention, a method for operating a drive assembly with an Otto engine and with an exhaust gas cooling system is being put forward. In a preferred embodiment, the Otto engine is a high-compression Otto engine. The preferred embodiment can also be referred to as a supercharged or high-compression Otto engine. Preferably, the combustion air fed into the cylinder of the Otto engine is compressed at a geometric compression ratio greater than 1:10 and smaller than 1:20. The Otto engine is especially a direct-injection Otto engine. In other words, in a preferred embodiment, the fuel is injected directly into the cylinder.

With the method according to the invention, combustion air that is fed into a cylinder of the Otto engine through an intake valve is compressed by an exhaust gas turbocharger having a turbine with a variable geometry. The exhaust gases fed to the turbine are cooled according to the invention in a section of the exhaust gas line, especially between an outlet valve of the Otto engine and the turbine of the exhaust gas turbocharger. Preferably, the exhaust gases are cooled in an exhaust manifold. It is especially advantageously integrated into a cylinder head of the Otto engine.

The intake valve is closed before a piston in the cylinder reaches the lowermost position of the cylinder. The exhaust gas turbocharger preferably comprises a turbine wheel and a compressor wheel that are connected to each other on a shaft. The turbine wheel is driven by the exhaust gas flow of the Otto engine. The compressor wheel is arranged in a combustion-air feed system of the Otto engine and, driven by the turbine wheel that is coupled by the shaft, it compresses the combustion air that is fed into the cylinders of the Otto engine. The effective flow cross section at the turbine inlet is configured to be variable. For this purpose, adjustable guide vanes can be arranged, for example, in the turbine housing of the exhaust gas turbocharger in which the turbine wheel is arranged. By adjusting the setting of the guide vanes, the rotational speed of the turbine wheel can be varied while the exhaust gas flow stays the same, as a result of which the compression generated by the compression wheel, the so-called charge pressure, can be varied. As an alternative, the effective flow cross section can be varied, for example, by means of a sliding collar. The exhaust gas turbocharger with a variable turbine geometry preferably has a radial turbine and a radial compressor. At the turbine wheel inlet, there can be a guide vane mimic that is adjusted by an electric actuator. Here, the effective flow cross section upstream from the turbine wheel can be varied by turning the guide vanes.

Due to the early closing of the intake valve, before the piston reaches the lowermost position, the compression ratio of the Otto engine can be increased without causing engine knocking. Since the flow cross section at the turbine inlet is variable, the useful turbine characteristics become broader. The actuation of the turbine is especially carried out as a function of the requisite charge pressure. As the engine load increases, a higher charge pressure is needed. In order to generate this, the flow cross section at the turbine is reduced for purposes of generating a higher turbine power. Here, in contrast to a case involving a diesel engine, the minimum flow cross section of the turbine is limited by the maximum permissible exhaust gas counter-pressure. Thus, the actuation also differs from that for the exhaust gas turbocharger having a waste gate, since here, such a limitation is not necessary in view of the principle employed.

Consequently, the use of an exhaust gas turbine with a variable geometry leads to broader useful turbine characteristics, so that already at medium loads of the Otto engine, sufficient charge pressure can be generated to compensate for charge losses that might arise due to the early closing of the intake valve. Therefore, a considerable increase in the total thermodynamic efficiency can be achieved, especially in these operating ranges. Due to the early closing of the intake valve, the combustion air is additionally cooled in the cylinder during the intake stroke due to expansion. This results in reduced compression work as well as in a reduced process temperature, thereby diminishing the knocking tendency and the wall heat losses.

Moreover, with the technique according to the invention, the exhaust gas temperature can be reduced, thereby permitting a thermal configuration of the exhaust gas turbocharger to the exhaust gas temperatures that are low for Otto engines, for instance, 850° C. [1562° F]. As a result, a material selection can be made and a gap size of the exhaust gas turbocharger for Otto engines can be dimensioned in a way that is analogous to modern diesel engines, as a result of which costs can be reduced for the exhaust gas turbocharger with a variable turbine geometry. Moreover, due to the reduced gap size, the turbine efficiency can be increased. Thus, according to the present method, a power-neutral increase in efficiency can be achieved in comparison to an Otto engine operated with the Miller combustion cycle having an exhaust gas turbocharger with a fixed turbine geometry.

According to one embodiment, the variable turbine geometry of the exhaust gas turbocharger is set as a function of the load of the Otto engine. The charge loss associated with the early closing of the intake valve can be suitably compensated for in all load ranges of the Otto engine by setting the variable turbine geometry by means of the broader compressor characteristics of the exhaust gas turbocharger with a variable turbine geometry. Moreover, especially in full-load operation, the process temperature and the exhaust gas temperature can be lowered, as a result of which the efficiency of the Otto engine is increased, and less expensive materials can be used in the exhaust gas system and in the turbine of the exhaust gas turbocharger.

According to another embodiment, the combustion air fed to the cylinder is additionally compressed by an electrically driven compressor, a so-called electric booster or e-booster. Due to the early closing of the intake valve, before the piston reaches the lowermost position of the cylinder, the air charge is reduced, that is to say, the ratio of the actual air volume—fed to the cylinder—to the theoretically maximum air volume in the cylinder is reduced. Due to the reduced air charge, the response time of the Otto engine can take longer, especially in response to a request for the engine speed or the torque to be increased. The electrically driven compressor can shorten the response time of the Otto engine in that the combustion air is pre-compressed using the electrically driven compressor, and thus the exhaust gas turbocharger is accelerated. The electric drive of the compressor has, for example, a power consumption of less than 1 KW and can therefore be operated with a 12 volt network that is normally present in a vehicle. Moreover, when the exhaust gas turbocharger with a variable turbine geometry is combined with an electrically driven compressor, the electrically driven compressor can be operated just briefly in order to improve the response time of the Otto engine, and therefore, no measures are needed to increase the electric capacity of the electric network of the vehicle.

Thanks to the combination of an exhaust gas turbocharger with a compressor that is driven mechanically by the crankshaft, as put forward in several embodiments, it is possible to achieve very broad compressor characteristics. As a result, charge losses caused by the early closing of the intake valve can be compensated for over broad speed and load ranges of the Otto engine. Thus, in turn, a power-neutral efficiency increase of the Otto engine can be achieved over a broad load range of the Otto engine.

According to a refinement of the invention, the shunt valve of the exhaust gas turbocharger can be set as a function of the load of the Otto engine. The shunt valve allows a set fraction of exhaust gases to bypass a turbine of the exhaust gas turbocharger. Such a shunt valve is also referred to as a waste gate or bypass valve. With the shunt valve, especially at high speeds of the Otto engine, broad compressor characteristics can be provided, even in the full load range, as a result of which the compensation for the charge losses can be set in a suitable manner.

According to another especially advantageous refinement, the Otto engine has an exhaust gas recirculation line, whereby exhaust gases that are fed via the exhaust gas recirculation line are cooled. The exhaust gas recirculation line can comprise, for example, a so-called high-pressure exhaust gas recirculation line and/or a so-called low-pressure exhaust gas recirculation line. The high-pressure exhaust gas recirculation line couples the exhaust gas circulation line between the outlet valves of the Otto engine and the turbine of the exhaust gas turbocharger to a combustion air feed between the compressor and the intake valves. The low-pressure exhaust gas recirculation line couples an exhaust gas circulation line downstream from the turbine of the exhaust gas turbocharger to a combustion air feed upstream from the compressor. Through the cooling of the exhaust gas recirculation line, the combustion air fed to the Otto engine can be cooled and thus the process temperature can be reduced. The exhaust gas recirculation can be effectuated, for example, by means of the engine coolant using, for instance, an integrated exhaust manifold. In particular, the exhaust gas cooling for the recirculated exhaust gases can be the same one that acts on the exhaust gases that are fed to the turbine of the exhaust gas turbocharger.

The efficiency advantage comes to the fore mainly in terms of an increase in the engine power. Here, modern Otto engine concepts have to lower the process temperature by means of an additional fuel feed to the cylinder so that the components that carry exhaust gases can be protected from excessive thermal stress. As a rule, this results in a high additional consumption of fuel. By using the integrated exhaust manifold, this measure can be markedly reduced and consequently, the efficiency of the engine can be increased by several percentage points, yielding a higher engine power. In comparison to the use of conventional exhaust gas recirculation systems, the exhaust gas temperature can be markedly reduced by means of the integrated exhaust manifold.

Moreover, the intake valve can be closed within the crankshaft angular range of 35° to 90° of the Otto engine before the lowermost position is reached between the intake stroke and the compression stroke. The intake valve can especially be closed within a crankshaft angular range of 50° to 70° of the Otto engine before the lowermost position is reached. The closing of the intake valve involves one millimeter of valve lift, that is to say, the intake valve is closed within the above-mentioned crankshaft angular range to such an extent that the remaining valve lift is smaller than or equal to one millimeter. Due to the early closing of the intake valve, the combustion air that had been fed in until then expands over the further course of the intake stroke, as a result of which the combustion air cools off. This causes reduced compression work during the subsequent compression stroke and also a reduced process temperature, as a result of which the knocking tendency of the Otto engine as well as the wall heat losses can be reduced. At the same time, the full expansion ratio is available for the power stroke.

According to another embodiment, the Otto engine comprises a variable valve control. The angle at which the intake valve closes is set by means of the variable valve control as a function of the load of the Otto engine. By setting the angle at which the intake valve closes, the air charge can be set as a function of the load, so that a throttle-free regulation of the engine load is made possible, thus allowing a power-neutral increase in efficiency.

In addition or as an alternative to this, the exhaust gases are cooled between an outlet valve of the Otto engine and the exhaust gas turbocharger by cooling an exhaust manifold of the Otto engine. By cooling the exhaust gases upstream from the exhaust gas turbocharger, a thermal configuration of the exhaust gas turbocharger towards lower exhaust gas temperatures is possible, as a result of which less expensive material can be selected and the gap size can be reduced.

Moreover, according to the present invention, a drive assembly with an Otto engine is being put forward. The drive assembly comprises an exhaust gas turbocharger having a turbine with a variable geometry and a valve control. The exhaust gas turbocharger is configured to compress combustion air that is fed through an intake valve into a cylinder of the Otto engine. The valve control is configured to close the intake valve before a piston in the cylinder reaches the lowermost position, especially between an intake stroke and a compression stroke. The Otto engine is thus particularly well-suited to carry out the above-mentioned method with one or more of the described features, and consequently, it also entails the above-mentioned advantages. In particular, the Otto engine permits an increase in efficiency as compared to conventional Otto engines, whereby the power of the Otto engine is not diminished by the increase in efficiency.

According to the invention, the drive assembly has an exhaust gas cooler that is associated with a section of an exhaust gas line in order to cool the exhaust gas that is fed to this turbine in the section of the exhaust gas line. In several embodiments, this section of the exhaust gas line is an exhaust manifold. In an advantageous manner, it is preferably partially or (especially preferably) completely integrated into a cylinder head of the Otto engine.

In the case of an integrated exhaust manifold, the usually separately configured exhaust manifold is completely integrated into the cylinder head and consequently, one single pipe connection leading to the turbine remains behind the outlet of the cylinder head. In order to prevent the temperature of this section from becoming impermissibly high, the gas-carrying contour is configured so as to be surrounded by coolant. This coolant jacket can also consist of multi-part cast cores. In particular, the coolant can be water.

The drive assemblies according to the invention can have an Otto engine with a geometric compression ratio within the range from 1:10 to 1:20, preferably 1:12 to 1:15, especially 1:13. Such large compression ratios are possible since an air charge <1 is set by means of the early closing of the intake valve, as a result of which a knocking tendency of the Otto engine can be prevented. The air charge is set, for example, to a range of 0.5 to 0.9, preferably to a range of 0.6 to 0.8.

According to the present invention, finally, a vehicle, especially a non-rail land vehicle, is being put forward which has the described drive assemblies with an Otto engine. Due to the improved efficiency of the Otto engine, the consumption and emissions of the vehicle, especially the CO₂ emissions, can be reduced. Since the increase in efficiency, as was described above, can be achieved in a power-neutral manner, the driver does not experience any power losses when operating the vehicle.

Preferred embodiments of the present invention are described in detail below, making reference to the drawing.

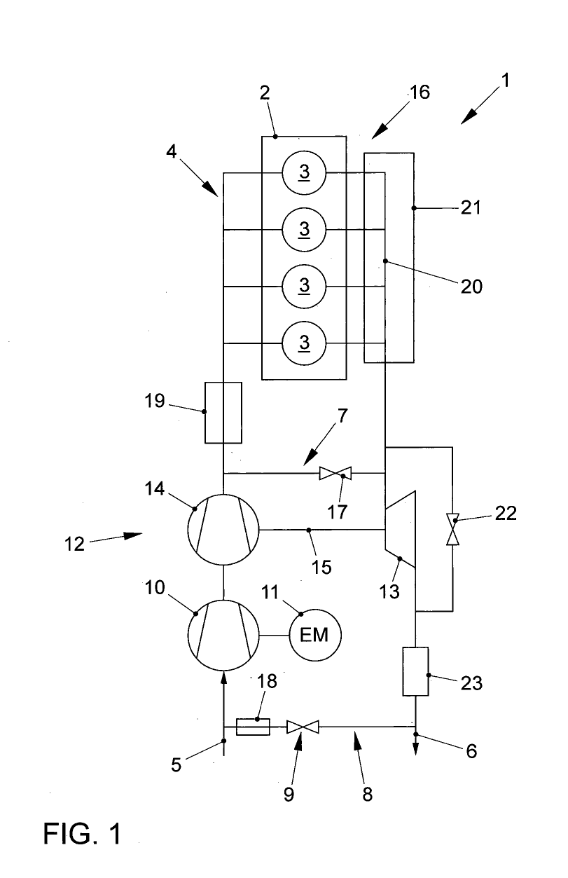

FIG. 1 a schematic depiction of a drive assembly with an Otto engine according to an embodiment of the present invention;

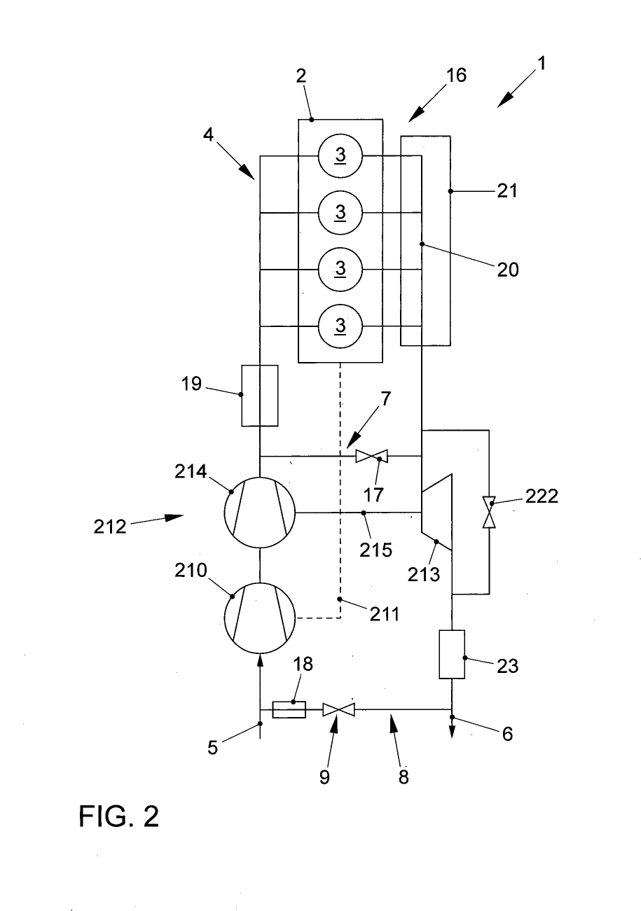

FIG. 2 another schematic depiction of a drive assembly with an Otto engine according to another embodiment of the present invention;

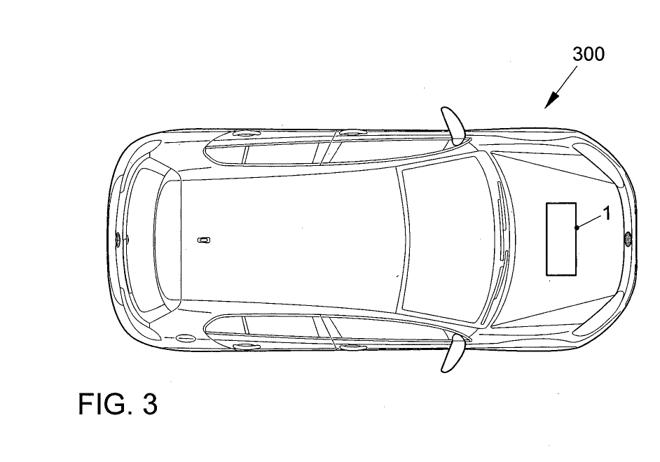

FIG. 3 a schematic depiction of a vehicle according to the invention with an embodiment of the invention.

The thermodynamic efficiency of conventional Otto engines is limited in because of the throttling of the quantitative load control and because of the reduced compression ratio that are needed to prevent engine knocking. The so-called Miller cycle or Atkinson cycle constitutes an approach towards dethrottling during partial load operation and possibly increasing the geometric compression ratio. Here, the air charge and the effective compression are reduced through an early or late closing of the intake valve. As a result, the engine is dethrottled and the compression end temperature and thus the knocking tendency are reduced, or else the geometric compression is increased. The air charge that indicates the ratio of the actual air volume and the theoretically maximum air volume after the intake stroke can be reduced by the Miller cycle, for example, from 0.95 to 0.5-0.9. Due to the reduced air charge, however, a power loss can occur. In order to prevent this power loss and nevertheless to achieve the increase in efficiency on the basis of the Miller cycle, according to one embodiment of the present invention, an Otto engine is being put forward that has a high-compression Miller cycle and an exhaust gas turbocharger with a variable turbine geometry. In order to achieve the high-compression Miller cycle, the intake valve is closed before a piston reaches the lowermost position of a given cylinder. The intake valve can be closed, for example, within a crankshaft angular range of 90° to 35° before the lowermost position is reached. Preferably, the intake valve can be closed within a crankshaft angular range of 70° to 50° before the lowermost position is reached.

FIG. 1 shows an embodiment of a drive assembly with an Otto engine 1. The Otto engine 1 is preferably an Otto engine. The Otto engine 1 comprises a cylinder block 2 having four schematically indicated cylinders 3. On the intake side 4, combustion air is fed to the Otto engine 1 via intake valves which are not shown in the figure. The intake valves can comprise a variable valve train so that it is possible to variably set the crankshaft angle at which an intake valve closes. The Otto air that is fed to the intake side 4 contains fresh air 5 as well as combustion exhaust gases 6 that are mixed with the fresh air 5 via exhaust gas recirculation lines 7 and 8. The fresh air 5 is mixed with exhaust gases 6 via an adjustable low-pressure exhaust gas recirculation line 8 having a low-pressure exhaust gas recirculation valve 9. In addition, the exhaust gas fed via the low-pressure exhaust gas recirculation line 7 [sic] is cooled by a cooler 18. This mixture is compressed by an electronically driven compressor, a so-called e-booster. The e-booster comprises a compressor 10 that is driven by an electric motor 11. Via an actuation means (not shown here) of the electric motor 11, the compression performed by the compressor 10 can be variably set.

In this embodiment, the air that has been compressed by the compressor 10 is fed to an exhaust gas turbocharger 12 with a variable turbine geometry. The exhaust gas turbocharger 12 comprises a turbine 13 driven by the exhaust gas of the Otto engine 1, and a compressor 14, both of which are connected to each other via a shared shaft 15. The combustion air compressed by the compressors 10 and 14 can be fed via the high-pressure exhaust gas recirculation line 7 from an exhaust gas side 16 of the Otto engine 1. In order to establish the exhaust gas recirculation via the high-pressure exhaust gas recirculation line 7, the high-pressure exhaust gas recirculation line 7 has a high-pressure exhaust gas recirculation valve 17. The combustion air that has been thus compressed and mixed with exhaust gases is fed to the intake side 4 via a charge air cooler 19. The exhaust gases of the four cylinders 3 coming from the exhaust gas side 16 are collected in an exhaust manifold 20 and fed to the high-pressure exhaust gas recirculation line 7 as well as to the turbine 13 with a variable geometry. In order to cool the exhaust gases, the exhaust manifold 20 can include an exhaust gas cooler 21, which is cooled, for instance, with cooling water.

The exhaust gas turbocharger 12 also comprises an optional shunt valve 22 through which a variable portion of the exhaust gases of the Otto engine 1 can bypass the turbine 13 of the exhaust gas turbocharger 12. Upstream from the turbine 13, the Otto engine 1 has an exhaust gas treatment system 23, for example, a three-way catalytic converter. The Otto engine 1 also comprises a gasoline injection system, preferably a gasoline direct-injection system, which injects the fuel directly into the cylinder 3.

Based on the supercharged Otto engine 1 having, for example, a gasoline direct-injection system, the volumetric efficiency is used to set the valve train variables in terms of the phase, control range and cylinder cutout for a throttle-free regulation of the engine load. At the same time, the cylinder block 2 of the Otto engine 1 has an elevated geometric compression ratio, for example, within a range from approximately 12 to 14. In order to reduce the associated high knocking tendency at the higher partial load and full load operation, the air charge is set to <1, for example, within a range of 0.5 to 0.9 or preferably 0.6 to 0.8, through the early closing of the intake. Moreover, in the operating state that is effectuated under charge pressure, the exhaust gas that is cooled and converted by the low-pressure exhaust gas recirculation line 8 is recirculated in order to increase the specific heat capacity of the exhaust gas. As was shown in FIG. 1, exhaust gas is withdrawn downstream from the catalytic converter 23 by means of the low-pressure exhaust gas recirculation line 8, subsequently filtered, cooled and returned upstream from the compressors 10 and 14. The charge loss associated with this is compensated for by increasing the intake pipe pressure employing the compressors 10 and 14. Thus, in principle, part of the compression of the working gas is brought about by the compressors 10 and 14 rather than taking place in the cylinder. By means of an appropriately dimensioned charge air cooler 19, the compressed working gas is recooled before the remaining compression in the cylinder 3 takes place. Due to the early closing of the intake, an additional cooling of the working gas takes place in the cylinder 3 due to expansion during the intake or inlet stroke. This results in reduced compression work as well as in a reduced process temperature, which diminishes the knocking tendency and the wall heat losses in the cylinder block 2. At the same time, the full expansion ratio of the geometric compression ratio is available for the power stroke. The elevated cooling capacity required for cooling the charge air and for recirculating the exhaust gas is largely compensated for by a reduced heat input into the engine coolant.

In order to supercharge the Otto engine 1, an exhaust gas turbocharger 12 with a variable turbine geometry is used in combination with an e-booster 10, 11. In contrast to a conventional exhaust gas turbocharger having a shunt valve 22, sufficient charge pressure can already be generated at medium loads thanks to the variable geometry of the turbine 13 and the associated variable turbine characteristics in order to compensate for the above-mentioned process-related charge losses. Moreover, the entire mass flow of the exhaust gas can be guided via the turbine, as a result of which more turbine power is available during full-load operation. This results in a considerable increase in the total thermodynamic efficiency, especially in the cycle-relevant operating ranges. Due to the reduced process temperature and an advantageous preferred cooling 21 of the exhaust manifold 20, the exhaust gas turbocharger 12 can be thermally dimensioned for exhaust gas temperatures that are low for Otto combustion methods, for example, a maximum of 850° C. [1562° F.]. As a result, less expensive materials can be selected and the gap size can be reduced as compared to conventional exhaust gas turbocharger concepts with a variable turbine geometry for Otto engines. Thanks to the material selection, the costs of the exhaust gas turbocharger can be reduced and, due to the reduced gap size, a higher turbine efficiency can be achieved in comparison to conventional exhaust gas turbochargers for Otto engines.

To summarize, due to the reduced process temperature resulting from the cooled pre-compression, due to the inner expansion with early closing of the intake, due to the cooling of the recirculated exhaust gas, due to the increased geometric compression ratio, and due to the associated prolonged expansion, the above-mentioned work process leads to a reduced exhaust gas temperature when the outlet valve is opened. The combination of the above-mentioned work process (high-compression Miller cycle) and the exhaust gas turbocharger with a variable turbine geometry is thus decisive for a power-neutral increase in efficiency by means of the high-compression Miller cycle and for sufficiently low exhaust gas temperatures that permit the use of economically and technologically feasible resources when an exhaust gas turbocharger with a variable turbine geometry is employed.

FIG. 2 shows another embodiment of an Otto engine 1 that is suitable, for example, for a higher specific power output per unit of displacement. The drive assembly with the Otto engine 1 in FIG. 2 can have an exhaust gas turbocharger 212 with a fixed turbine geometry instead of the turbocharger 12 with a variable turbine geometry. In other words, the exhaust gas turbocharger 212 comprises a turbine 213 with a fixed turbine geometry. In addition, the exhaust gas turbocharger 212 has a shunt valve 222 that is also referred to as a waste gate or bypass valve. As an alternative, the drive assembly can have an exhaust gas turbocharger 212 that has a variable turbine geometry and that is coupled via a shaft 215 to a compressor 214. Diverging from the embodiment shown in FIG. 1, the Otto engine 1 of FIG. 2 comprises—instead of the e-booster 10, 11—a mechanically driven compressor 210 that is coupled via a drive 211 to a crankshaft of the Otto engine 1 and that is driven by the crankshaft. Such a concept consisting of a mechanically driven compressor 210 and an exhaust gas turbocharger 212 is also referred to as a twin-charger concept. The other components of the Otto engine 1 of FIG. 2 are the same as the components of the Otto engine 1 of FIG. 1. An intake valve of the Otto engine 1 is closed before the corresponding piston reaches the lowermost position. Therefore, the Otto engine 1 of FIG. 2 also functions according to the Miller cycle.

The reduction in the exhaust gas temperature at a reduced air charge in comparison to conventional Otto engines—which was described above in conjunction with FIG. 1—results in a reduced exhaust gas enthalpy that is available to the exhaust gas turbocharger for transient operating states such as, for example, a spontaneous load demand. With the Otto engine concepts that are common nowadays, an increase in the exhaust gas enthalpy occurs due to a late adjustment of the ignition angle and thus of the combustion. This leads to efficiency losses during transient engine operation. In order to improve the Otto engine response time, which is delayed due to the reduced air charge, a pre-compressor, for instance, the e-booster 10, 11 shown in FIG. 1, or the mechanically driven compressor 210 shown in FIG. 2, is integrated into the supercharging system. The pre-compressor is positioned downstream from the air filter in the intake path upstream from the main compressor 14 or 214. By generating pressure values of less than 1.5 hPa, the exhaust gas turbocharger 12 or 212 is accelerated and thus achieves the desired response times. With smaller engines, a drive power of the e-booster 10, 11 within the range of less than 1000 Watts is sufficient, that is to say, the electric motor 11 can be operated at least briefly with electric energy from the 12 Volt on-board network. In the case of larger engines, however, the electric power of a 12 Volt on-board network is often not enough. In these cases, the mechanically driven pre-compressor 210 that is mechanically driven by the crankshaft of the Otto engine 1 is advantageous.

Finally, FIG. 3 shows a vehicle 300 according to an embodiment of the present invention that has the drive assembly with the Otto engine 1 described above.

1. A method for operating a drive assembly with an Otto engine and with an exhaust gas cooling system, comprising:
compressing combustion air that is fed through an intake valve into a cylinder of the Otto engine by means of an exhaust gas turbocharger with a turbine that has a variable geometry, and
closing the intake valve before a piston in the cylinder reaches the lowermost position, and
cooling of the exhaust gas fed to the turbine in a section of the exhaust gas line.

2. The method according to claim 1, wherein the exhaust gas is cooled in an exhaust manifold (20).

3. The method according to claim 1, wherein an exhaust manifold that is integrated into a cylinder head of the Otto engine is used to cool the exhaust gas.

4. The method according to claim 1,

5. The method according to claim 1, wherein the combustion air fed to the cylinder is additionally compressed by an electrically driven compressor.

6. The method according to claim 1, wherein the intake valve is closed within the crankshaft angular range of 35° to 90° of the Otto engine before the lowermost position is reached.

7. The method according to claim 1, wherein the Otto engine comprises a variable valve control, whereby the angle at which the intake valve closes is set as a function of the load of the Otto engine.

8. The method according to claim 1, wherein fuel is injected directly into the cylinder.

9. The method according to claim 1, wherein the combustion air fed into the cylinder of the Otto engine is compressed at a geometric compression ratio greater than 1:10 and smaller than 1:20.

10. A drive assembly, comprising:
an Otto engine,
an exhaust gas turbocharger having a turbine with a variable geometry, to compress combustion air that is fed through an intake valve into a cylinder of the Otto engine, and
a valve control that is configured to close the intake valve before a piston in the cylinder reaches the lowermost position, and
an exhaust gas cooler that is associated with a section of an exhaust gas line in order to cool the exhaust gas that is fed to the turbine in the section of the exhaust gas line.

11. The drive assembly according to claim 10, wherein the section of the exhaust gas line is an exhaust manifold.

12. The drive assembly according to claim 11, wherein the exhaust manifold is integrated into a cylinder head of the Otto engine.

13. The drive assembly according to claim 10, wherein the Otto engine has a geometric compression ratio greater than 1:10 and smaller than 1:20.

14. The drive assembly according to claim 13, wherein the Otto engine has a geometric compression ratio greater than 1:12 and smaller than 1:15.

15. A vehicle with a drive assembly according to claim 10.
